(19) United States
(12) Patent Application Publication
(10) Pub. No.: US 2005/0096769 A1
(43) Pub. Date: May 5, 2005

(54) Industrial information technology (IT) workflow optimizer for discrete manufacturing

(76) Inventors: Deia Salah-Eldin Bayoumi, Fuquay Varina, NC (US); William John Vick, Cary, NC (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/699,041

(22) Filed: Oct. 31, 2003

(51) Int. Cl. G06F 19/00

(52) U.S. Cl. 700/99; 700/28; 700/104; 715/700

(57) ABSTRACT

The invention contemplates a system and method offering optimization and management of manufacturing resources to obtain optimal manufacturing capacities and to avoid manufacturing down-time currently realized through manual operation and control of manufacturing resources. In an illustrative implementation, the present invention contemplates an exemplary optimization computing application operating in a computing environment which communicates with, cooperates with, and provides optimization data for use in managing manufacturing resources (e.g. manufacturing machines). The computing application accepts a variety of manufacturing related information as input, processes such manufacturing data and generates optimization suggestions for use to manage manufacturing processes and to optimize manufacturing capacities. The optimization data may be applied to a particular manufacturing environment to control the operation of manufacturing resources such that optimization is realized.

### FIELD OF THE INVENTION

The invention relates to the field of discrete manufacturing, and more particularly, to optimization of manufacturing workflow.

### BACKGROUND OF THE INVENTION

Manufacturing of any detailed product is a complex process that requires extensive co-ordination between various entities, both within the same organization and outside the organization. Such manufacturing includes material need determinations, cost negotiations, material availability determinations, and warehousing considerations, just to name a few. Each of these entities typically is responsible for discrete portions of the manufacturing process, including order processing, supplier integration, and process feedback. It follows, therefore, that manufacturing requires getting the right information to the right place at the right time. Today, some of discrete entities or processes of the manufacturing process are automated computing systems. However, the communication and integration among the various entities is lacking. Often this lack of integration is a result of the various different entities that are responsible for the many different aspects of the overall manufacturing process. As a result, completing the entire manufacturing process often requires extensive human interaction between each of the various discrete entities or processes.

In addition, the entity that is ultimately responsible for the end product often is at the mercy of the individual material suppliers. Yet, often the communication to the end product manufacturer from the discrete entities is inconsistent. This inconsistent communication leads to missed production deadlines and eventually the arduous process of identifying new suppliers. In addition, inventories kept by the end product manufacturer often have low visibility, such that material acquisition requests often come too late, especially for long lead time material items.

Moreover, coordination and control of the manufacturing processes across an enterprise having geographically disparate manufacturing locations poses several challenges which are not currently addressed. With human intervention a loose management of critical manufacturing data and, more importantly, management over manufacturing machinery results. Specifically, in discrete manufacturing, workshop floors typically have groups of machines with the same functionality and other groups of machines having differing functionality. These machines work in coordination to execute the many varied tasks that are part of a product's manufacturing process. Conventionally, in practice, the planning engineers distribute the tasks to manufacturing plant foremen, charging them to schedule manufacturing runs on the manufacturing plant's varied machines. The foremen are left to manually schedule the manufacturing runs often without knowledge of enterprise manufacturing optimization data yielding inefficient and non-optimal manufacturing. In the case that machines malfunction or break work is either queued or moved to any available machine without considering the current loading or future loading schedule of manufacturing orders. This lack of optimization intelligence and execution may lead to costly delays in the manufacture of products resulting in unsatisfied customers and loss in revenue.

Therefore, there is a need to provide automation and communication among the discrete manufacturing processes in real-time, both local and remotely to manufacturing resources to obtain optimal and error free manufacturing of products.

### SUMMARY OF THE INVENTION

The invention contemplates a system and method offering optimization and management of manufacturing resources to obtain optimal manufacturing capacities and to avoid manufacturing down-time currently realized through manual operation and control of manufacturing resources. In an illustrative implementation, the present invention contemplates an exemplary optimization computing application operating in a computing environment which communicates with, cooperates with, and provides optimization data for use in managing manufacturing resources (e.g. manufacturing machines). The computing application accepts a variety of manufacturing related information as input, process such manufacturing data and generates optimization suggestions for use to manage manufacturing processes and to optimize manufacturing capacities. The optimization data may be applied to a particular manufacturing environment to control the operation of manufacturing resources such that optimization is realized.

Further to the illustrative implementation, the exemplary optimization computing application provides a tool that optimizes the control and workflow between groups of similarly functioning machines as well as the overall assembly lines for the entire manufacturing process. The optimization computing application operates on a number of variables when generating optimization suggestions and data. Such variables include but are not limited to resources (labor and machines) and time. In operation, the tool is fed with data representative of the entire manufacturing process from end to end, including cycle times and resources assigned for each cycle. The exemplary optimization computing application also processes the machines' capability, capacity and functionality in conjunction with the machines' workload to generate optimization suggestions that may include the assignment of tasks to machines. Such processing aims to obtain the optimal use of resources with the minimum manufacturing time. The exemplary optimization computing application operates to process data of a group of machines as well as the entire manufacturing assembly line.

In the provided implementation, the optimization computing application is in constant (real time) communication with the manufacturing resources to obtain information about the resource operations and operational status. Using this real-time feed, the optimization computing application is capable of handling contingencies such as if one of the machines is off-line or delayed finishing tasks.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary embodiments of the invention; however, the invention is not limited to the specific methods and instrumentalities disclosed. In the drawings:

FIG. 1 is a block diagram of an exemplary computing system that may support the present invention;

FIG. 1a is a block diagram of an exemplary network environment in which the present invention may be employed;

FIG. 1b is a block diagram illustrating the cooperation of the exemplary control computing application with manufacturing resources;

FIG. 2 is a block diagram of a manufacturing optimization system;

FIG. 3 is a flow diagram illustrating an exemplary optimization process in accordance with the herein described systems and methods;

### DETAILED DESCRIPTION OF ILLUSTRATIVE EMBODIMENTS

Illustrative Computing Environment

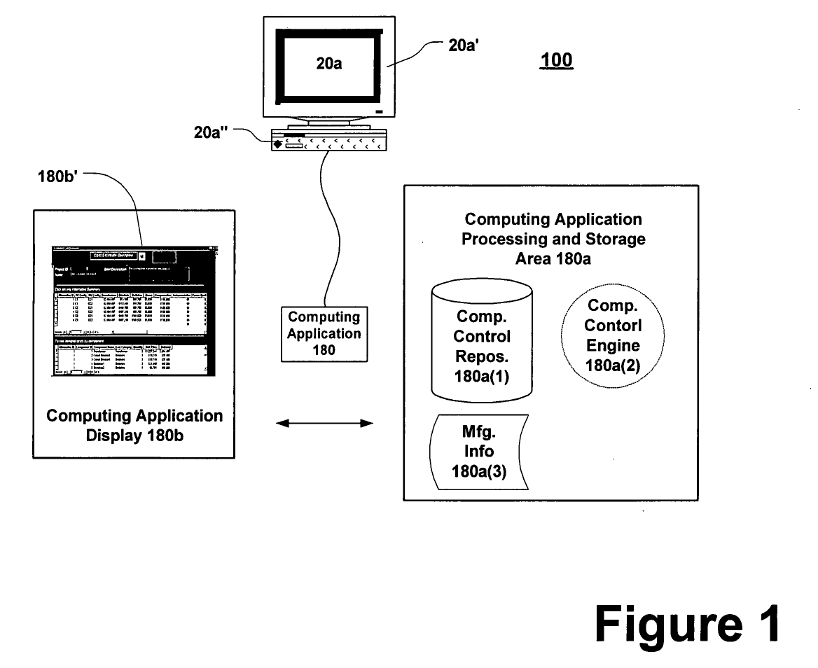

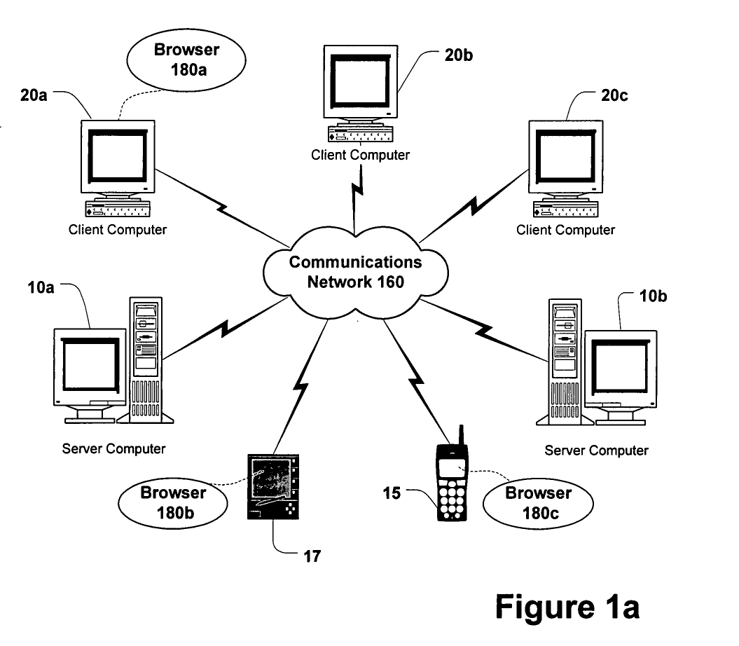

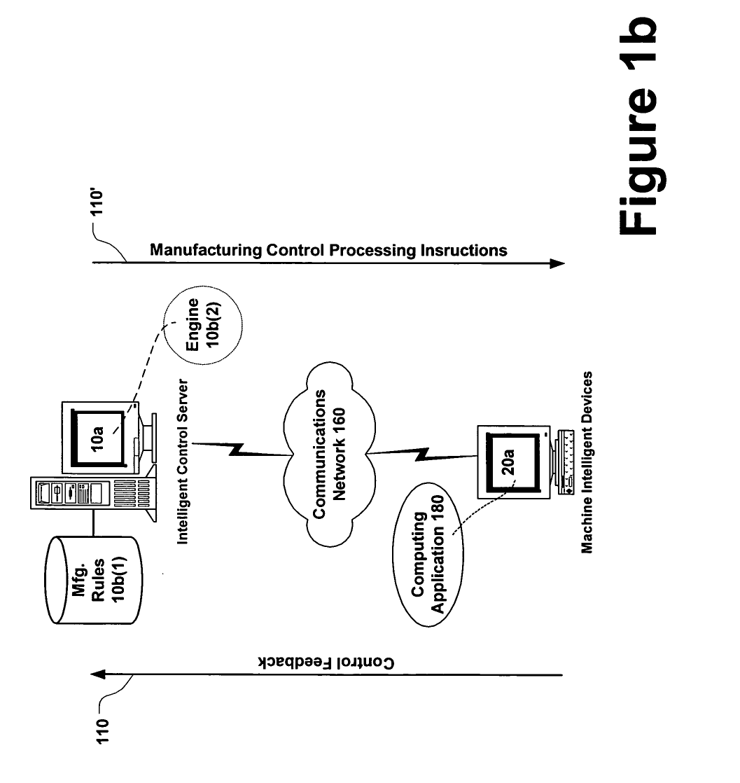

FIG. 1 shows computing system 100 that may support the present invention. Computing system 100 comprises computer 20a that may comprise display device 20a′ and interface and processing unit 20a″. Computer 20a may support computing application 180. As shown, computing application 180 may comprise computing application processing and storage area 180a and computing application display 180b. Computing application processing and storage area 180a may contain manufacturing computer control rules and instructions repository 180a(1), manufacturing computer control engine 180a(2), and manufacturing information 180a(3). Similarly, computing application display 180b may comprise display content 180b′. In operation, a participating user (not shown) may interface with computing application 180 through the use of computer 20a. The participating user (not shown) may navigate through computing application 180 to input, display, and generate data representative of power system manufacturing optimization. Manufacturing resource optimization solutions and analysis may be created by computing application 180 using the manufacturing computer control rules and instructions repository 180a(1), manufacturing computer control engine 180a(2), and manufacturing information 180a(3) of computing application processing and storage area 180a and shown to a participating user (not shown) as display content 180b′ on computing application display 180b.

Illustrative Computer Network Environment

Computer 20a, described above, can be deployed as part of a computer network. In general, the above description for computers applies to both server computers and client computers deployed in a network environment. FIG. 1a illustrates an exemplary network environment, with a server in communication with client computers via a network, in which the present invention may be employed. As shown in FIG. 1a, a number of servers 10a, 10b, etc., are interconnected via a fixed-wire or wireless communications network 160 (which may be a LAN, WAN, intranet, the Internet, or other computer network) with a number of client computers 20a, 20b, 20c, or computing devices, such as, mobile phone 15, and personal digital assistant 17. In a network environment in which the communications network 160 is the Internet, for example, the servers 10 can be Web servers with which the clients 20 communicate via any of a number of known communication protocols, such as, hypertext transfer protocol (HTTP) or wireless application protocol (WAP). Each client computer 20 can be equipped with browser 180a to gain access to the servers 10. Similarly, personal digital assistant 17 can be equipped with browser 180b and mobile phone 15 can be equipped with browser 180c to display and receive various data.

In operation, a participating user (not shown) may interact with a computing application running on a client computing device to generate manufacturing resource optimization solutions for discrete manufacturing environments. The optimization solutions may be stored on server computers and communicated to cooperating users through client computing devices over communications network 160. A participating user may create, track, manage, and store manufacturing solutions and cost analysis information by interfacing with computing applications on client computing devices. These transactions may be communicated by client computing devices to server computers for processing and storage. Server computers may host computing applications for the processing of optimization information relevant to discrete manufacturing environments.

Thus, the present invention can be utilized in a computer network environment having client computing devices for accessing and interacting with the network and a server computer for interacting with client computers. However, the systems and methods providing resource optimization as described by the systems and methods disclosed herein can be implemented with a variety of network-based architectures, and thus should not be limited to the example shown. The systems and methods disclosed herein will be described in more detail with reference to a presently illustrative implementation.

Manufacturing Optimization Solution Generation

FIG. 1b shows the cooperation of various computing elements when generating manufacturing resource optimization for discrete manufacturing environments in a computing environment. Cooperating machines through machine intelligent devices 20a may employ computing application 180a to send control feedback data to intelligent control server 10a over communications network 160. In response, intelligent control server 10a may process the request by cooperating with adaptable and updateable machine control computer rules and instructions data store 10b(1), and adaptable and updateable machine control computer engine 10b(2) to generate and communicate manufacturing control processing instructions. The manufacturing control processing instructions can then be communicated to machine intelligent devices 20a over communications network 160. At machine intelligent devices 20a, the manufacturing control processing information is processed for execution on cooperating machines (not shown).

In the herein provided illustrative implementation, intelligent devices are depicted as computers. Such depiction is merely exemplary as machine intelligent devices 20a may comprise one or more computing elements that may or may not be integrated with cooperating machines.

Workflow Overview

Automation in manufacturing, as an endeavor to improve productivity has been an ongoing concern in mass production systems. Keen competition in the global marketplace has motivated enterprises across various industries to analyze workflow in manufacturing to achieve competitive advantages. Workflow management addresses the interaction between cooperating components of a process or system to identify resources and task resources to achieve predefined targets and goals. The basis of effective workflow management is information—information about a variety of variables of the cooperating components of the system or a process. Such information may include operational status of one or more of the components, loading information for each of the system's/process' components, status information about the components, and production yield. In having such information, resources may be better tasked to perform at optimal capacities.

As technology has advanced, workflow coordination and management has shifted from an arduous manual exercise to one that is either entirely automated or assisted by computing technologies. With semi-automated and automated workflow management and coordination tools, enterprises have obtained a better handle on resource allocation and on productivity. In the context of discrete manufacturing, however, there is a void for an effective workflow optimization system and methods that generate optimization instructions for manufacturing resources to ensure that manufacturing is being performed at an optimal and efficient manner.

Overview

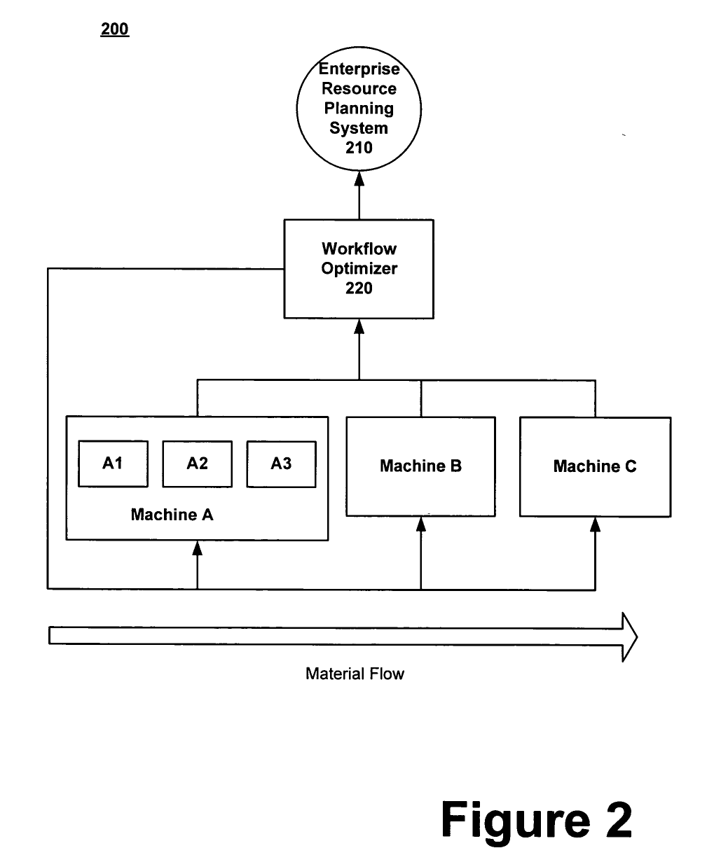

The invention contemplates a technique for providing workflow optimization over machine units or groups of machine units in a discrete manufacturing environment such that manufacturing resources are optimized and to avoid costly manufacturing down time. FIG. 2 is a block diagram of a workflow optimization system 200, according to the invention. It should be appreciated that the block diagram shown in FIG. 2 is just one example of a technique for accomplishing the invention. FIG. 2 is not meant to be the exclusive example, but is provided for the purpose of understanding the invention.

As is shown in FIG. 2, workflow optimization system 200 comprises enterprise resource planning (ERP) system 210, workflow optimizer 220, machine type A, machine B, and machine C. Further, as is shown, machine type A comprises three machines A1, A2, and A3, respectively. Workflow optimizer 220 cooperates with ERP system 410 to provide ERP system 210 data representative of workflow for machines A1, A2, A3, machine B, and machine C. Additionally, workflow optimizer 220 cooperates with machines A1, A2, A3, machine B, and machine C to obtain, in real time, data representative of operating conditions and status, loading, and production from such machines.

In operation, machines A1, A2, A3, machine B, and machine C cooperate with each other as part of a manufacturing environment to produce one or more products. As indicated by the material flow arrow, the output of machines A1, A2, and A3 may act as input to machine B, and the output of machine B, may act as input to machine C. Machine C may then be responsible for finishing the final product (not shown). In the illustrative implementation, it can be seen that if one or more the machines becomes non-operational, manufacturing process is halted resulting in manufacturing down-time. However, in the instance that one or more of machines A1, A2, or A3 fails, one or more of the non-failing machines of machine type A can compensate for the other failed machine(s). That is if machine A1 fails, machines A2 and A3 can compensate for failed machine A1.

Workflow optimizer 220 operates to communicate with the manufacturing resources (e.g. machines A1, A2, A3, machine B, and machine C) to obtain a variety of information for use in determining whether such machine is being optimized as part of the overall manufacturing process. Workflow optimizer 220 may comprise a computing applet executing one or more optimization algorithms to identify inefficiencies and to provide optimization instructions. In addition to manufacturing resource information, workflow optimizer 220, cooperates with ERP system 210 to identify planning and project management information. Such planning and project management information is processed in conjunction with the manufacturing resource data using the described optimization algorithms to generate the described optimization instructions. It is in the context of an enterprise's overall manufacturing plan and project planning and management that optimization of manufacturing resources is achieved. Without enterprise intelligence, the optimization instructions would have only meaning in the local discrete manufacturing environment without consideration for manufacturing processes occurring across an enterprise.

In the provided implementation, workflow optimizer 220 may comprise a computing application (not shown) which is in communication with the manufacturing resources over a communications infrastructure (not shown). Furthermore, the cooperating manufacturing resources may comprises one or more components for gathering manufacturing resource data (e.g. intelligent data acquisition module or controller) for communication to workflow optimizer 220. Such information is processed by the exemplary workflow optimization computing application using some optimization algorithms and heuristics. Additionally, in the illustrative implementation, workflow optimizer 220 may cooperate with ERP system 210 over the same or similar communications infrastructure (not shown) that workflow optimizer 220 employs to communicate with the manufacturing resources. Workflow optimizer 220 obtains planning and project management data from ERP system 210 that is processed by workflow optimizer 220 in conjunction with manufacturing resource data according to optimization algorithms and heuristics to generate optimization instructions. In operation, generated optimization instructions are communicated to manufacturing resources through the described communications infrastructure (not shown) for execution by the manufacturing resources. Additionally, workflow optimizer 220 communicates generated optimization instructions to ERP system 210 so that planning and project management may be better coordinated across an enterprise.

It is appreciated that although workflow optimizer 420 is described as employing optimization algorithms, that such description is merely illustrative as optimization instructions may be generated according to a variety of optimization techniques.

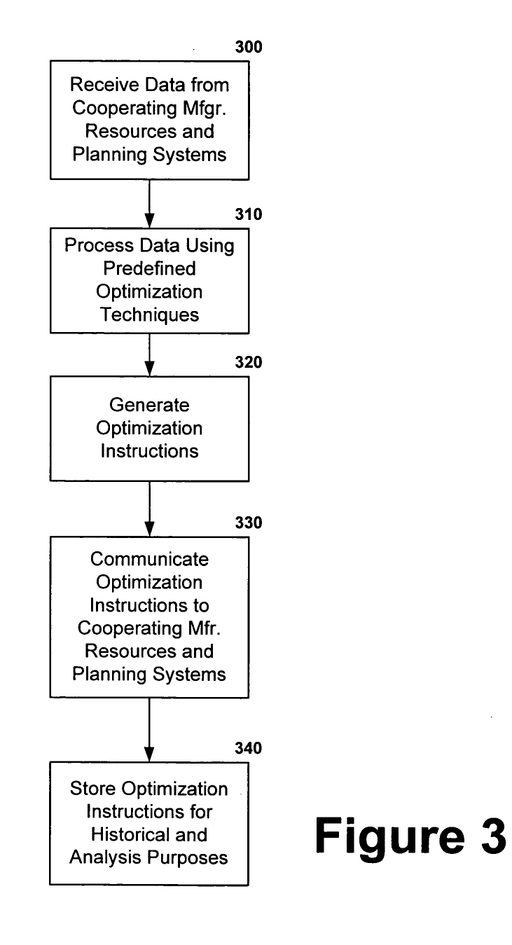

FIG. 3 shows the processing performed by the exemplary workflow optimization system to generate optimization instructions. As is shown processing begins at block 300 where data is received from cooperating manufacturing resources and planning systems. The data is then processed using predefined optimization techniques at block 310. The results of processing step 310 is the generation of optimization instructions at block 320. The generated optimization techniques are then communicated to cooperating manufacturing resources and planning systems at block 330. Lastly, the optimization instructions are stored at block 340 for historical and analysis purposes.

At block 310, the data is processes according to pre-defined optimization techniques. The invention herein described is not limited to any exclusive optimization technique but rather relies on a best of breed approach wherein a number of optimization techniques may be employed in conjunction to obtain the desired optimization information.

In sum, the herein described systems and methods generate workflow optimization techniques and instructions using manufacturing environment rules and heuristics for communication to and execution by cooperating manufacturing resources. It is understood, however, that the invention is susceptible to various modifications and alternative constructions. There is no intention to limit the invention to the specific constructions described herein. On the contrary, the invention is intended to cover all modifications, alternative constructions, and equivalents falling within the scope and spirit of the invention.

It should also be noted that the present invention may be implemented in a variety of computer environments (including both non-wireless and wireless computer environments), partial computing environments, and real world environments. The various techniques described herein may be implemented in hardware or software, or a combination of both. Preferably, the techniques are implemented in computer programs executing on programmable computers that each include a processor, a storage medium readable by the processor (including volatile and non-volatile memory and/or storage elements), at least one input device, and at least one output device. Program code is applied to data entered using the input device to perform the functions described above and to generate output information. The output information is applied to one or more output devices. Each program is preferably implemented in a high level procedural or object oriented programming language to communicate with a computer system. However, the programs can be implemented in assembly or machine language, if desired. In any case, the language may be a compiled or interpreted language. Each such computer program is preferably stored on a storage medium or device (e.g., ROM or magnetic disk) that is readable by a general or special purpose programmable computer for configuring and operating the computer when the storage medium or device is read by the computer to perform the procedures described above. The system may also be considered to be implemented as a computer-readable storage medium, configured with a computer program, where the storage medium so configured causes a computer to operate in a specific and predefined manner.

Although an exemplary implementation of the invention has been described in detail above, those skilled in the art will readily appreciate that many additional modifications are possible in the exemplary embodiments without materially departing from the novel teachings and advantages of the invention. Accordingly, these and all such modifications are intended to be included within the scope of this invention. The invention may be better defined by the following exemplary claims.

1. A system providing optimization over manufacturing resources of a discrete manufacturing environment, comprising:
a data store, the data store having optimization rules and heuristics for the discrete manufacturing environment; and
a workflow optimization engine, the workflow optimization engine cooperating with the data store to obtain manufacturing rules and/or heuristics for processing to generate workflow optimization data.

2. The system as recited in claim 1, further comprising a communications network, the communications network cooperating with the workflow optimization engine to communicate optimization data between the workflow optimization engine and cooperating manufacturing resources.

3. The system as recited in claim 2, wherein the communications network comprises any of: local area network, wide area network, extranet, intranet, peer-to-peer networks, and the Internet.

4. The system as recited in claim 3, wherein the communications network is wireless and/or fixed wire.

5. The system as recited in claim 1, wherein the workflow optimization engine comprises a computing application having one or more instruction sets to instruct a computing environment to process data representative of discrete manufacturing information.

6. The system as recited in claim 5, wherein the manufacturing information comprises any of: manufacturing resource capacity information, time for manufacturing information, manufacturing resource specifications, raw material information, and manufacturing environment information.

7. The system as recited in claim 1, wherein the workflow optimization engine cooperates with a plurality of manufacturing resources to obtain and process manufacturing information used in one ore more manufacturing processes.

8. The system as recited in claim 7, wherein the workflow optimization engine receives data from additional manufacturing optimization data resources comprising any of manual data, manufacturing control information, and planning information to generate at least one workflow optimization routine for use on cooperating manufacturing resources.

9. The system as recited in claim 8, wherein the workflow optimization engine utilizes an agent that executes one or more of artificial intelligence techniques to obtain the additional optimization data.

10. The system as recited in claim 1, wherein the woiflow optimization engine communicates with manufacturing resources in a real time manner obtaining manufacturing resource information comprising any of: operational status, change in capacity, production efficiency, and loading information.

11. The system as recited in claim 8, wherein the additional manufacturing optimization data is provided to the workflow optimization engine over a communications infrastructure.

12. A method for generating workflow optimization processes and techniques for use on manufacturing resources of a manufacturing environment comprising the steps of:
receiving request for the manufacture of a product or product component; and
processing the request by a workflow optimization engine, the workflow optimization engine having at least one instruction set to process data according to predefined manufacturing rules.

13. The method as recited in claim 12, wherein the further comprising communicating the processed data to at least one cooperating manufacturing resource.

14. The method as recited in claim 13, wherein the communicating step comprises establishing communications over a communications network with the manufacturing resource.

15. The method as recited in claim 14, further comprising retrieving from a cooperating data store data manufacturing rules and heuristics for the manufacturing environment.

16. The method as recited in claim 15, further comprising receiving data from cooperating additional manufacturing optimization resources comprising any of manual data, manufacturing control application, and planning systems for processing and to generate the manufacturing instructions.

17. A computer readable medium having computer readable instructions to instruct a computer to perform the method as recited in claim 12.

18. A method to generate workflow optimization instructions for manufacturing resources comprising:
providing a workflow optimization engine, the workflow optimization engine capable of receiving and processing data to generate workflow optimization instructions.

19. The method as recited in claim 18 further comprising, providing a data store, the data store cooperating with the workflow optimization engine providing manufacturing rules and manufacturing environment conditions.

20. The method as recited inc claim 18 further comprising, providing a communications network, the communication network cooperating with the workflow optimization engine to communicate workflow optimization instructions to cooperating manufacturing resources.

21. In an information technology system providing communication of data among a global power distribution equipment manufacturer enterprise, a module providing workflow optimization comprising:
a communications network, the communication network capable of receiving and transmitting data representative of power distribution equipment manufacturing processes;
a data store, the data store having data representative of power distribution equipment manufacturing processes;
a manufacturing control applet, the manufacture control applet cooperating with the communications network and the data store to receive data representative of power distribution manufacturing data, comprising any of power distribution system market information, design information, facilities capacity, planning, and materials information, for processing, such processing comprising any of generating manufacturing control instructions to control at least one cooperating manufacturing resource, wherein the applet communicates with the manufacturing resource to obtain manufacturing resource operational and status information, and wherein the manufacturing control applet uses the operational information to generate workflow optimization instructions for communication to and execution by cooperating manufacturing resources.

22. The system as recited in claim 21, wherein the data store has data representative of manufacturing resources and enterprise data comprising any of planning information, project information, and manufacturing control information.
